(19) United States
(12) Patent Application Publication
(10) Pub. No.: US 2021/0004399 A1
(43) Pub. Date: Jan. 7, 2021

(54) A SYSTEM FOR SHARING IMAGE INFORMATION

(71) Applicant: YuTzu Hsiao, New Taipei City (TW)

(72) Inventor: Hsiao Yu-Tzu, New Taipei City (TW)

(21) Appl. No.: 16/978,237

(22) PCT Filed: Nov. 8, 2018
(86) PCT No.: PCT/CN2018/115590

§ 371 Date: Sep. 4, 2020

(30) Foreign Application Priority Data
Mar. 8, 2018 (CN) 201810189193.8

(51) Int. Cl. G06F 16/535; H04L 29/08; G06F 21/62; G06F 16/51; G06F 16/25; G06F 16/587; G06F 16/955

(52) U.S. Cl. CPC G06F 16/535; H04L 67/306; G06F 21/6218; G06F 40/134; G06F 16/258; G06F 16/587; G06F 16/9558; G06F 16/51

(57) ABSTRACT

The present invention provides a system for sharing image information, which has a data processing device, comprising a non-transitory computer-readable storage medium storing computer program modules executable on the data processing device comprising: a network connection module for connecting to the data processing device via the network; a processor module for receiving a first image-associated data or an instruction from the data processing device by the network connection module and processing the first image-associated data according to the instruction to generate a second image-associated data; an account management module for defining an access right of a user on the network connection module via the network to the system for sharing image information and for managing account information of the user in the processor module, wherein the user inputs the instruction limited by the defined access right to process the first image-associated data and the second image-associated data according to the user's access rights; and a database for storing the first image-associated data, the second image-associated data, the instruction, or the user account information.

### RELATED APPLICATIONS

This application is a National Phase entry of PCT Application No. PCT/CN2018/115590, filed Nov. 8, 2018, the disclosure of which is hereby incorporated by reference herein in its entirety.

### BACKGROUND OF THE INVENTION

### 1. Field of the Invention

The present disclosure generally relates to a system for sharing image information, and, more particularly, to an integrated system for sharing image information.

### 2. Description of the Related Art

Mobile devices, such as smart-phones, tablet PCs, and other consumer electronics have become widespread and important to the daily activities of many users. Users communicate, share life experience with each other by social networking service systems on their mobile devices heavily. Social networking service systems allow users to search or share interesting information online.

However, there are varies of limitations in common social networking service systems, e.g. some limitations on sharing image information. For example, a user may find an interesting photo on the social networking service systems. The user cannot identify where the photo was taken directly, only when the uploader added location tags. Even though the user may identify the place shown in the photo by the image or the tags, the user has to search related information about the place by other search engine and to create the itinerary by other applications. As another example, a user may find a photo edited or retouched in certain style. The user would not know the camera settings or the retouching settings of the photo unless there are some additional explanations in the caption.

Therefore, there is a need in the industry to develop a system which not only allows users to share, edit and search images and the related information of the images but also is capable of presenting the images and the related information at the same time.

### SUMMARY OF THE INVENTION

In light of solving the foregoing problems of the prior art, the present invention provides a system for sharing image information, which has a data processing device, comprising a non-transitory computer-readable storage medium storing computer program modules executable on the data processing device comprising a network connection module for connecting to the data processing device via the network; a processor module for receiving a first image-associated data or an instruction from the data processing device by the network connection module and processing the first image-associated data according to the instruction to generate a second image-associated data; an account management module for defining an access right of a user on the network connection module via the network to the system for sharing image information and for managing account information of the user in the processor module, wherein the user inputs the instruction limited by the defined access right to process the first image-associated data and the second image-associated data according to the user's access rights; and a database for storing the first image-associated data, the second image-associated data, the instruction, or the user account information.

In an embodiment according to the present invention, the instruction comprises a format-converting instruction and the processor module converts the first image-associated data to the corresponding second image-associated data according to the format-converting instruction.

In an embodiment according to the present invention, the first image-associated data or the second image-associated data comprises a corresponding image setting information or image retouching information, and the database further stores the image setting information or image retouching information.

In an embodiment according to the present invention, the first image-associated data or the second image-associated data comprises a corresponding geographic information or time information; wherein the processor module generates a corresponding third image-associated data according to the geographic information or time information; and the database further stores the geographic information or time information.

In an embodiment according to the present invention, the processor module is further for creating a hyperlink to a predetermined webpage corresponding to the geographic information. The processor module is further for generating a corresponding itinerary information according to the geographic information; and the data processing device is for downloading the geographic information and the corresponding itinerary information by the network connection module via the network.

In an embodiment according to the present invention, the first image-associated data or the second image-associated data comprises a corresponding image setting information or image retouching information, and the database further stores the image setting information or image retouching information.

In an embodiment according to the present invention, the instruction further comprises a user group management instruction, wherein the account management module defines a corresponding user group access rights for the user according to the user group management instruction; and the processor module converts the first image-associated data to a second image-associated data according to the user group access rights.

In an embodiment according to the present invention, the instruction further comprises a searching instruction; the processor module searches the database to find out the corresponding first image-associated data, the corresponding second image-associated data, the corresponding instruction or the corresponding user account information from the database according to the searching instruction.

In an embodiment according to the present invention, the searching instruction comprises setting up a tag for the first image-associated data, the second image-associated data; the processor module further searches the database to find out the corresponding first image-associated data, the corresponding second image-associated data, the corresponding instruction or the corresponding user account information from the database according to the tag.

In an embodiment according to the present invention, the instruction comprises an editing instruction; the processor module is for editing the first image-associated data into the second image-associated data corresponding to the editing instruction according to the editing instruction.

As mentioned above, the system for sharing image information of the present invention is able to connect to the data processing device. The network connection module, the processor module, the account management module and the database are connected by the network, so the system for sharing image information of the present invention is able to process or generate the first image-associated data and the second image-associated data according to the instructions. By doing that, the user may read the image-associated data by the system while browsing the image. Therefore, the user may share images on the system for sharing image information of the present invention and share the image-associated data on the system at the same time.

### BRIEF DESCRIPTION OF THE DRAWINGS

FIG. 1 illustrates a schematic view of an exemplary embodiment of the system for sharing image information according to the present invention; and

FIG. 2 illustrates a schematic view of an exemplary embodiment of the system for sharing image information connected to an external server according to the present invention

### DETAILED DESCRIPTION

The present invention is described by the following specific embodiments. Those with ordinary skills in the arts can readily understand other advantages and functions of the present invention after reading the disclosure of this specification.

It should be noted that the structures, ratios, sizes shown in the drawings appended to this specification are to be construed in conjunction with the disclosure of this specification in order to facilitate understanding of those skilled in the art. They are not meant, in any ways, to limit the implementations of the present invention, and therefore have no substantial technical meaning. Without affecting the effects created and objectives achieved by the present invention, any modifications, changes or adjustments to the structures, ratio relationships or sizes, are to be construed as fall within the range covered by the technical contents disclosed herein. Meanwhile, terms, such as “top”, “bottom”, “inner”, “external”, “one”, “a” and the like, are for illustrative purposes only, and are not meant to limit the range implementable by the present invention. Any changes or adjustments made to their relative relationships, without modifying the substantial technical contents, are also to be construed as within the range implementable by the present invention.

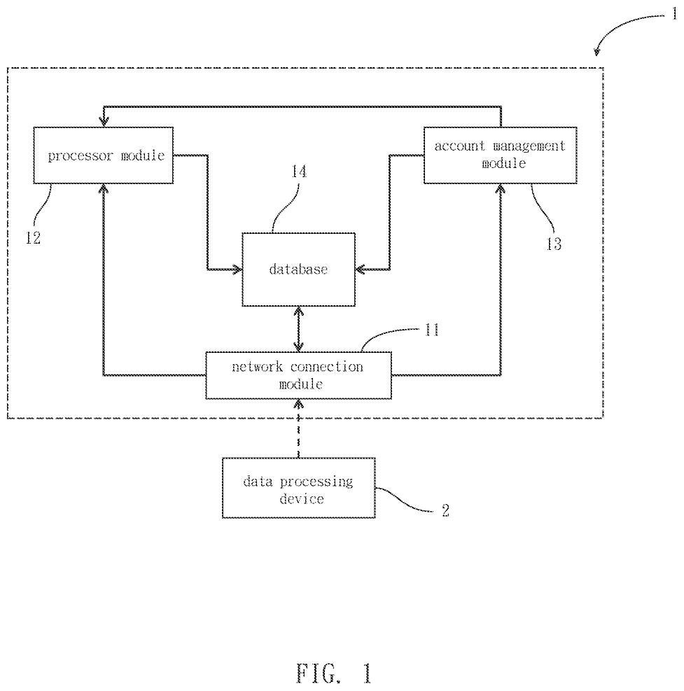

Please refer to FIG. 1. The present invention provides a system for sharing image information 1, which has a data processing device 2. The system comprising a non-transitory computer-readable storage medium storing computer program modules executable on the data processing device comprises: a network connection module 11, a processor module 12, an account management module 13, and a database 14. The network connection module 11 may be used for connecting to the data processing device 2 via the network (e.g., internet); the data processing device 2 may transfer a first image-associated data or an instruction by the network connection module 11 and the processor module 12 may be used for receiving the first image-associated data or the instruction and further used for processing the first image-associated data according to the instruction to generate a second image-associated data;

the account management module 13 may be used for defining an access right of a user on the network connection module 11 via the network to the system for sharing image information 1 and further used for managing account information of the user in the processor module 12, wherein the user inputs the instruction limited by the defined access right to process the first image-associated data and the second image-associated data according to the user's access rights; the database 14 may be used for storing the first image-associated data, the second image-associated data, the instruction, or the user account information.

According to an embodiment of the present invention, the system for sharing image information 1 may be a server system. The server system may provide services on the external network by the network connection module 11. Or, the server system may provide services on the internal network. In this embodiment of the present invention, the system for sharing image information 1 may work individually. Otherwise, a plurality of systems for sharing image information 1 may work cooperatively via the network. Preferably, the system for sharing image information 1 of the present invention may further connect to an external server via the network.

According to the embodiment of the present invention, the data processing device 2 may be a terminal device which is able to grab or access images and access to the network, such as, but not limited to a smart-phone, a pad, a laptop, a personal computer, a camera or the like. It should be understood that the terms “data processing device” and “terminal device” may be the same and shown in the specification alternatively.

According to the system for sharing image information 1 may be connected to the data processing device 2 by the network connection module 11 via the network.

According to an embodiment of the present invention, the predetermined first image-associated data may be transferred by the data processing device 2 via the network. The processor module 12 may receive the first image-associated data by the network connection module 11. According to the present invention, the first image-associated data may comprises the original data of the predetermined image, for example, but not limited to, the image file of the predetermined image, the filming date and time of the predetermined image, the geographic information of the place where the predetermined image was filmed or the image setting information or image retouching information, such as aperture, shutter speed, ISO, camera brands and models or the like. In this embodiment, the processor module 12 may be, for example, but not limited to, a CPU on a single chip, a CPU on chips array, a GPU on a single chip, a GPU on chips array, a flash memory module, an integrated circuit, a single PC, a PC array, a single server, a server array or the like.

According to another embodiment of the present invention, the data processing device 2 may further process or adjust the predetermined image according to the instruction. The adjustment may be such as, but not limited to, contrast adjustment, saturation adjustment, the information of the retouching layer, annotations or the like. In this embodiment, the first image-associated data may further comprise contrast adjustment, saturation adjustment, the information of the retouching layer, annotations and the like information.

In this embodiment, the annotations may be any information related to the image, such as the photographer's name or nickname, the reviews or ratings of the content in the image, e.g. the ratings of the restaurant or food in the image, the ratings of the content in the image by artificial intelligence; the image recognition information; the image recognition information recognized by artificial intelligence, but not limited.

In this embodiment, the processor module 12 may process the first image-associated data according to the instruction to generate a second image-associated data which comprises image data being processed by the system or the like.

According to an embodiment of the present invention, the instruction may comprise a format-converting instruction and the processor module 12 may further convert the first image-associated data to the second image-associated data corresponding to the format-converting instruction according to the format-converting instruction. The format-converting instruction may allow the processor module 12 to support varies of file formats of the image to be shown on the system for sharing image information 1. The varies of file formats of the image may be, for example, but not limited to, uploaded photos, live photos, animated GIFs, live videos/audios, live augmented reality, panoramic photos/videos, links to videos, links to photos, links to others or the like. In this embodiment, the processor module 12 may comprise a codec device or a codec program.

According to an embodiment of the present invention, the first image-associated data or the second image-associated data may comprise a corresponding image setting information or image retouching information, for example, but not limited to, the filming date and time of the predetermined image, the geographic information of the place where the predetermined image was filmed or the image setting information or image retouching information, such as aperture, shutter speed, ISO, camera brands and models and so on, contrast adjustment, saturation adjustment, the information of the retouching layer, annotations and so on. The database 14 may further store the corresponding image setting information or image retouching information.

According to an embodiment of the present invention, the first image-associated data or the second image-associated data comprises a corresponding geographic information or time information. The processor module 12 may further generate a third image-associated data according to the corresponding geographic information or time information, and the database 14 may further store the corresponding geographic information or time information. In this embodiment, the processor module 12 may comprise a computing unit which is used for analyzing the first image-associated data or the second image-associated data to generate the corresponding third image-associated data.

According to an embodiment of the present invention, the third image-associated data may be a hyperlink or a link. The processor module 12 may create a hyperlink which links to one or more predetermined images processed by the system for sharing image information 1 and the hyperlink can be shared by the users.

According to an embodiment of the present invention, the corresponding third image-associated data may be a text content corresponding to the predetermined image. The system for sharing image information 1 may process multiple predetermined images to a blog format and the processor module 12 may generate different text contents corresponding to each of the images. The text contents may be the date or time when the image was filmed, the geographic information, brief comments or the like. Specifically, the processor module 12 may generate a first text content according to the first predetermined image processed by the system for sharing image information 1 and generate a second text content according to the second predetermined image processed by the system for sharing image information land so on. The processor module 12 of the system for sharing image information 1 of the present invention may sequence or sort the multiple images by the first image-associated data of the predetermined images, such as the time or date when the images were filmed or the geographic information. The multiple images filmed in the same period and in close locations may be arranged in chronological order by the filming time and the geographic information where the images were filmed may be annotated. Furthermore, the processor module 12 may generate text content corresponding to those images according to the chronological order and the geographic information where the images were filmed. On the other hand, according to an embodiment of the present invention, the corresponding third image-associated data may be an itinerary corresponding to the images. The processor module 12 may execute a program to generate an itinerary to the locations where the images were filmed in chronological order by the geographic information and the filming time.

According to the preferable embodiment of the present invention, the third image-associated data may be a hyperlink. The processor module 12 may further generate or create a hyperlink to a predetermined webpage corresponding to the geographic information. For example, the processor module 12 may generate a hyperlink linking to the travel websites or search and list travel information about the itinerary related to the geographic information on the displaying device of the processor module 12. For example, but not limited to, the hyperlink may link to hotel booking websites and show the rooms and prices of the hotels near the location according to the geographic information; link to airline flight ticket websites and show the flight information; link to travel rating websites and show the recommended tourist attractions or restaurants; or link to travel agencies and show the tours provided by the travel agencies. According to another embodiment of the present invention, after the processor module 12 generates a hyperlink linking to the travel websites or search and list travel information about the itinerary related to the geographic information on the displaying device of the processor module 12, the processor module 12 may further receive a restrict instruction to allow the specific travel information on the displaying device of the processor module 12. Preferably, the system for sharing image information 1 of the present invention may sort the travel information by the price or other parameters according to the above-mentioned travel information.

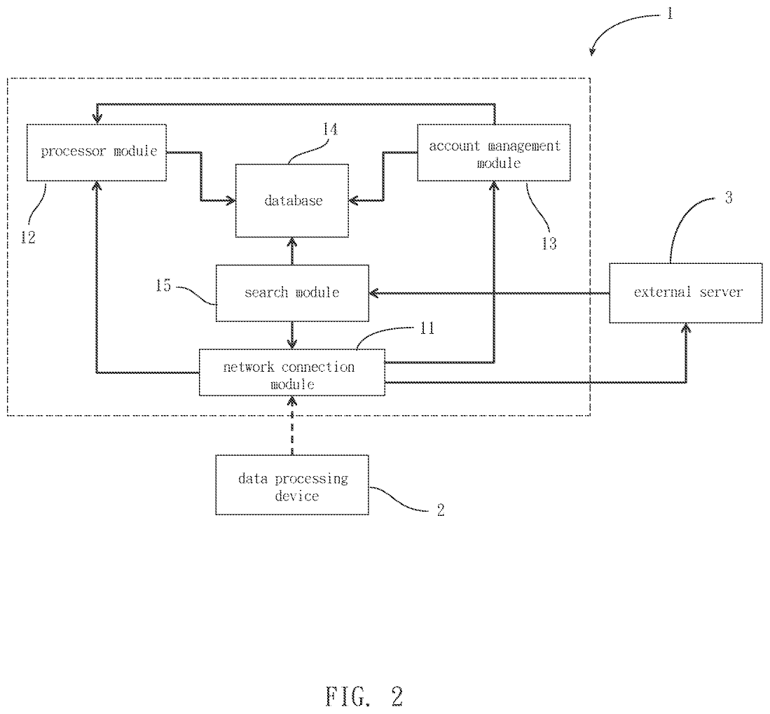

In this embodiment, the data processing device 2 may upload the predetermined images and the first image-associated data to the system for sharing image information 1 of the present invention. The system for sharing image information 1 of the present invention may further comprise a search module 15 which may be actively or passively accessed by a device with corresponding access right to the related information by the network connection module 11 via the network. The searching module 15 may send a searching instruction according to a predetermined image and the first image-associated data to an external server to run a data search. Please refer to FIG. 2. The external server 3 may be used for receiving and execute the searching instruction and transfer the searching results via the network; and the searching module 15 may further receiving the searching results. For example, the searching module 15 may transfer the geographic information of the predetermined image and the searching instruction to the external server 3. After the external server 3 finishes the search, it may transfer the resulted searching information, like accommodation choices and tourist attractions near the location, to the system for sharing image information 1 of the present invention. As another example, the searching module 15 may transfer the predetermined image and the searching instruction to an external server 3. The external server 3 may further recognize the products in the predetermined image and run a search. The external server 3 may further transfer the resulted searching information, like the brand of the product, the price, and where to buy it, back to the searching module 15. Preferably, the system for sharing image information 1 of the present invention may further sort the resulted searching information by the price or other parameter.

Preferably, the searching results may be computed by the system for sharing image information 1 and the data processing device 2 and be shown on the displaying device of the data processing device 2.

According to an embodiment of the present invention, the data processing device 2 may download the geographic information by the network connection module 11 via the network and generate a corresponding itinerary information according to the geographic information. For example, the predetermined images processed by the system for sharing image information 1 of the present invention may generate corresponding geographic information and time information for each of the images. The processor module 12 may tag those geographic information in the positioning system of the terminal device, the positioning system of other device or the positioning system of the system for sharing image information of the present invention. The processor module 12 may compute the modes of transport and the required time among those location according to the geographic information and time information. In some embodiments, the processor module 12 may further generate an itinerary information for a certain area according to the modes of transport and the required time among those location and the geographic information. The data processing device 2 may download the geographic information and the corresponding itinerary information by the network connection module 11 via the network.

According to an embodiment of the present invention, the first image-associated data or the second image-associated data may further comprise a corresponding image setting information or image retouching information, for example, but not limited to, aperture, shutter speed, ISO, camera brands and models and so on; contrast adjustment, saturation adjustment, the information of the retouching layer, annotations or the like. The database 14 may further store the corresponding image setting information or image retouching information.

According to an embodiment of the present invention, the instruction may further comprise a user group management instruction. According to a preferable embodiment of the present invention, the account management module 13 may define a user group access right for the user according to the user group management instruction and transfer it to the predetermined terminal device. The user group access rights may be a right to upload, a right to open all or some of the information, a right to access all or some of the information in different level.

For example, when a user logs in account A in different terminal devices, the user may have the same access right as the user group access rights of the account A. Alternatively, when a user logs in account A in different terminal devices, the user may have different right to upload and different right to access all or some of the information, but same right to open all or some of the information as the rights of the account A.

According to an embodiment of the present invention, the user group access right may define the grouping way for the image-associated data, and all the terminal devices for uploading or downloading are requested by the user group access right to comply the same requirements and agreements as the same as the system for sharing image information of the present invention does.

For example, a user group access right of the terminal device A defines and groups multiple image-associated data. The image-associated data may be grouped according to the image-associated information by their definitions. For example, the brightness information, such as aperture, shutter speed, ISO, or brightness adjustment; color information, such as color matrix information, saturation adjustment, icc profile information; the information of the layers, such as, the information of the retouching layer, the text layer; the itinerary information, such as the geographic information, the time when the image was filmed. Terminal device A may transfer those group of information to the system for sharing image information 1 of the present invention vis the network. As another example, the user group access right of the system for sharing image information 1 of the present invention may authorize the right to the user A to access different groups of information. The group of the image-associated information may further comprise system information, time to upload, rating information by the system, and the like. The system information may limit the upload of the other image-associated information to the system for sharing image information 1 of the present invention. The first image-associated information, the second image-associated information or the third image-associated information may be deleted from the system for sharing image information 1 by the user group access right of the terminal device A.

According to an embodiment of the present invention, the user group access rights may define the right to upload and the right to access all or some of the information to the uploaded image-associated information. The right to open all or some of the information and the right to access all or some of the information may be authorized by the mutual agreement between different user terminal devices and the system for sharing image information 1.

According to an embodiment of the present invention, The right to open all or some of the information may be adjusted to different user group. For example, the user group access rights of the terminal device A may choose to open the predetermined images and the image-associated data on the system for sharing image information 1 to the public. Or, terminal device A may choose to open some chosen the predetermined images and the image-associated data on the system for sharing image information 1 to the user group with the user group access rights B1 and open all the predetermined images and the image-associated data on the system for sharing image information 1 to the user group with the user group access rights B2. The person having ordinary skills in the art understand the right to open all or some of the information and the right to access all or some of the information of the terminal device A may be authorized by the mutual agreement between terminal device A, the system for sharing image information 1, the user group with the user group access rights B1 and the user group with the user group access rights B2.

According to an embodiment of the present invention, the user group with the user group access rights B may choose if it would receive those images and the image-associated information, including the first image-associated information, the second image-associated information, and the third image-associated information within the right. For example, terminal device B2 may choose to receive one or more image-associated data, including the first image-associated information, the second image-associated information, and the third image-associated information, which the terminal device A open to the user group with the user group access rights B2. In this embodiment, one or more image-associated data which the terminal device A open to the user group with the user group access rights B2 may be shown on the terminal device B2 and allow the user group with the user group access rights B2 to read. Preferably, the user group A and the user group B may further share the readable image and the image-associated data, including the first image-associated information, the second image-associated information, and the third image-associated information to the other system or platform, not limited to the system for sharing image information of the present invention.

According to an embodiment of the present invention, users may read the images and the image-associated data within their access right, including the first image-associated information, the second image-associated information, and the third image-associated information and store certain images and the image-associated data. The users may store by downloading the certain images and the image-associated data, including the first image-associated information, the second image-associated information, and the third image-associated information in his terminal device. Or, the user may tag the certain image or the image-associated data. The database 14 of the system for sharing image information may further store the tagged image or the image-associated data for the user to read in the database 14 via the network.

According to an embodiment of the prevent invention, the instruction may further comprise a searching instruction, The processor module 12 may search out the corresponding first image-associated data, the second image-associated data, the instruction or the user account information from the database 14 according to the searching instruction. For example, the terminal device may search the public images, image-associated information and the public image-associated content in the system for sharing image information 1 by image search or text search within the access right.

According to a preferable embodiment of the prevent invention, the searching instruction may further comprise setting up a tag for the first image-associated data, the second image-associated data. The processor module 12 may further search out the corresponding first image-associated data, the second image-associated data, the instruction or the user account information from the database 14 according to the tag.

According to another embodiment of the prevent invention, the instruction may comprise an editing instruction. The processor module 12 may be used for editing the first image-associated data into the second image-associated data according to the editing instruction.

In this embodiment, the second image-associated data may comprise text and image, such as the text or other images related to the predetermined image or the text or other images related to the first image-associated data. According to this embodiment, the processor module 12 may create a hyperlink linking to the image processed by the system for sharing image information 1 of the present invention for the user to share. According to another embodiment, the system for sharing image information 1 may process multiple predetermined images to a blog format and the processor module 12 may generate different text contents corresponding to each of the multiple images.

According to an embodiment of the present invention, the instruction may be inputted in the data processing device 2 by the network connection module 11 via the network. The data processing device 2 may be used for downloading and storing the first image-associated data, the second image-associated data, the instruction or the user account information.

The data processing device 2 may upload multiple predetermined images, including photos or videos, by the network connection module 11 to the system for sharing image information 1 provided by the present invention. Meanwhile, the processor module 12 may generate multiple text corresponding to each of the images and may generate the second image-associated data, including the itinerary information according to the geographic information and the time when the images were filmed of the uploaded images. The data processing device 2 may upload the second image-associated data by the network connection module 11 via the network and the other terminal devices may download the second image-associated data. The data processing device 2 may further tag certain images in the system for sharing image information 1 and the first image-associated data and the second image-associated data thereof. The data processing device 2 may upload the settings of the certain images to the system for sharing image information 1 and the other terminal devices may download the settings of the certain images.

As mentioned above, the system for sharing image information 1 of the present invention is able to connect to the data processing device 2. The network connection module 11, the processor module 12, the account management module 13 and the database 14 are connected by the network, so the system for sharing image information 1 of the present invention is able to process or generate the first image-associated data and the second image-associated data according to the instructions. The user may read the image-associated data by the system while browsing the images. Therefore, the user may share images on the system for sharing image information 1 of the present invention and share the image-associated data on the system at the same time.

Preferably, the system for sharing image information of the present invention may be configured on devices which are able to connect to the network and to compute data, such as a computer, a server or the combination thereof. The network connection module 11, the processor module 12, the account management module 13 and the database 14 may be a network communicating unit, a processor unit, a random access memory unit, a non-volatile memory unit with function as network connecting and data computing, respectively, and the software or firmware installed in and executed by the aforementioned units.

More preferably, the system for sharing image information of the present invention may be configured on devices which are able to connect to the network and to compute data, such as a computer, a server or the combination thereof in different places. The system for sharing image information of the present invention may be installed in, executed and achieved by the network communicating unit, the processor unit, the random access memory unit, the non-volatile memory unit which are able to connect to the network and to compute data, respectively, and the software or firmware installed in and executed by the aforementioned units.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A system for sharing image information, which has a data processing device, comprising a non-transitory computer-readable storage medium storing computer program modules executable on the data processing device comprising:
a network connection module for connecting to the data processing device via the network;
a processor module for receiving a first image-associated data or an instruction from the data processing device by the network connection module and processing the first image-associated data according to the instruction to generate a second image-associated data;
an account management module for defining an access right of a user on the network connection module via the network to the system for sharing image information and for managing account information of the user in the processor module, wherein the user inputs the instruction limited by the defined access right to process the first image-associated data and the second image-associated data according to the user's access rights; and
a database for storing the first image-associated data, the second image-associated data, the instruction, or the user account information.

2. The system for sharing image information of claim 1, wherein the instruction comprises a format-converting instruction and the processor module converts the first image-associated data to the corresponding second image-associated data according to the format-converting instruction.

3. The system for sharing image information of claim 1, wherein the first image-associated data or the second image-associated data comprises a corresponding image setting information or image retouching information, and the database further stores the image setting information or image retouching information.

4. The system for sharing image information of claim 1, wherein the first image-associated data or the second image-associated data comprises a corresponding geographic information or time information; wherein the processor module generates a corresponding third image-associated data according to the geographic information or time information; and the database further stores the geographic information or time information.

5. The system for sharing image information of claim 4, wherein the processor module is further for creating a hyperlink to a predetermined webpage corresponding to the geographic information.

6. The system for sharing image information of claim 4, wherein the processor module is further for generating a corresponding itinerary information according to the geographic information; and the data processing device is for downloading the geographic information and the corresponding itinerary information by the network connection module via the network.

7. The system for sharing image information of claim 6, wherein the first image-associated data or the second image-associated data comprises a corresponding image setting information or image retouching information, and the database further stores the image setting information or image retouching information.

8. The system for sharing image information of claim 6, wherein the instruction further comprises a searching instruction; the processor module searches the database to find out the corresponding first image-associated data, the corresponding second image-associated data, the corresponding instruction or the corresponding user account information from the database according to the searching instruction.

9. The system for sharing image information of claim 8, wherein the searching instruction comprises setting up a tag for the first image-associated data, the second image-associated data; the processor module further searches the database to find out the corresponding first image-associated data, the corresponding second image-associated data, the corresponding instruction or the corresponding user account information from the database according to the tag.

10. The system for sharing image information of claim 9, wherein the second image-associated data comprises a text and an image.

11. The system for sharing image information of claim 1, wherein the instruction further comprises a user group management instruction, wherein the account management module defines a corresponding user group access rights for the user according to the user group management instruction; and the processor module converts the first image-associated data to a second image-associated data according to the user group access rights.

12. The system for sharing image information of claim 1, wherein the instruction comprises an editing instruction; the processor module is for editing the first image-associated data into the second image-associated data corresponding to the editing instruction according to the editing instruction.

13. The system for sharing image information of claim 1 further comprising a search module, wherein the searching module sends a searching instruction according to a predetermined image and the first image-associated data to an external server to run a data search.

14. The system for sharing image information of claim 1, wherein the instruction is inputted in the data processing device by the network connection module via the network; the data processing device is for downloading and storing the first image-associated data, the second image-associated data, the instruction or the user account information.
